(19) United States
(12) Patent Application Publication
(10) Pub. No.: US 2025/0350517 A1
(43) Pub. Date: Nov. 13, 2025

(54) COMMUNICATION METHOD AND APPARATUS

(71) Applicant: HUAWEI TECHNOLOGIES CO., LTD., Shenzhen (CN)

(72) Inventors: Kuandong GAO, Shenzhen (CN); Huang HUANG, Chengdu (CN)

(21) Appl. No.: 19/273,356

(22) Filed: Jul. 18, 2025

Related U.S. Application Data
(63) Continuation of application No. PCT/CN2023/073255, filed on Jan. 19, 2023.

(51) Int. Cl. H04L 27/26; H04L 5/00; H04W 72/0453

(52) U.S. Cl. CPC H04L 27/2607; H04L 5/0098; H04W 72/0453

(57) ABSTRACT

A communication method and apparatus are provided. The method includes: receiving configuration information, where the configuration information includes one or both of the following indication information: whether cyclic shift is performed on a filter coefficient of a first communication apparatus, or whether cyclic shift is performed on data with the filter coefficient; and determining, based on the indication information, whether cyclic shift is performed on one or both of the filter coefficient of the first communication apparatus or the data with the filter coefficient. According to the method in embodiments of this application, in a scenario in which two terminals occupy completely overlapping or partially overlapping frequency domain resources, an access network device may configure cyclic shift of corresponding filter coefficients for different terminals, so that interference between the two terminals is reduced.

### CROSS-REFERENCE TO RELATED APPLICATIONS

This application is a continuation of International Application No. PCT/CN2023/073255, filed on Jan. 19, 2023, the disclosure of which is hereby incorporated by reference in its entirety.

### TECHNICAL FIELD

Embodiments of this application relate to the field of communication technologies, and in particular, to a communication method and apparatus.

### BACKGROUND

A peak to average power ratio is a ratio of maximum transient power to average power of a signal in a periodicity. If the peak to average power ratio of the signal is excessively high, the signal may be distorted. Signal filtering may be performed to shape the signal, so as to reduce the peak to average power ratio of the signal. How to perform signal filtering is a research direction.

### SUMMARY

Embodiments of this application provide a communication method and apparatus, to implement signal filtering.

According to a first aspect, a communication method is provided. The method is performed by a first communication apparatus, and the first communication apparatus may be a terminal, or may be a chip, a circuit, or the like in the terminal. The method includes: receiving configuration information, where the configuration information includes one or both of the following indication information: whether cyclic shift is performed on a filter coefficient of the first communication apparatus, or whether cyclic shift is performed on data with the filter coefficient; and determining, based on the indication information, whether cyclic shift is performed on one or both of the filter coefficient of the first communication apparatus or the data with the filter coefficient.

According to the foregoing implementation, in a scenario in which two terminals occupy completely overlapping or partially overlapping frequency domain resources, an access network device configures cyclic shift of corresponding filter coefficients for the two terminals, so that interference between the two terminals can be reduced, and communication quality can be improved.

In a possible implementation, the configuration information further includes the following indication information: a type of a filter of the first communication apparatus and precoding of the first communication apparatus. Alternatively, the type of the filter of the first communication apparatus and the precoding of the first communication apparatus may be preset, specified in a protocol, or configured by the access network device for the terminal by using information other than the configuration information, or the like. This is not limited in this application.

In a possible implementation, a value of the cyclic shift is preset, specified in a protocol, or configured by the access network device. For example, the value of the cyclic shift is half of a quantity of subcarriers included in a frequency domain resource of the first communication apparatus.

A roll-off factor of the filter is specified in a protocol, preset, or configured by the access network device. When the roll-off factor of the filter is configured by the access network device, the configuration information further includes indication information for the roll-off factor of the filter. For example, the roll-off factor of the filter may be a rational number greater than 0 and less than 1, or the roll-off factor of the filter is 0 or 1.

In a possible implementation, when the configuration information includes the indication information indicating whether cyclic shift is performed on the filter coefficient of the first communication apparatus, or the indication information indicating whether cyclic shift is performed on the data with the filter coefficient, the roll-off factor of the filter is 1.

In a possible implementation, when the configuration information includes the indication information indicating whether cyclic shift is performed on the filter coefficient of the first communication apparatus, or the indication information indicating whether cyclic shift is performed on the data with the filter coefficient, the method further includes: reserving M subcarriers outside a bandwidth of the first communication apparatus, where M is an integer greater than 0, and performing transmission of a zero value signal on the reserved M subcarriers, or performing, on the reserved M subcarriers, transmission of a non-zero value signal whose power is less than a threshold, where a value of M is determined based on the bandwidth of the first communication apparatus.

According to the foregoing implementation, energy of a signal at an edge is large when cyclic shift is performed on the filter. The greater the energy of the signal at the edge, the stronger the interference. To reduce the interference, M subcarriers may be reserved at edges of a frequency band of the first communication apparatus. The M subcarriers are used for transmission of a zero value signal, or transmission of a non-zero value signal whose power is less than a threshold, so that interference of the signal at the edge to another signal can be reduced.

According to a second aspect, a communication method is provided. The method is performed by a second communication apparatus, and the second communication apparatus may be an access network device, or may be a chip, a circuit, or the like in the access network device. The method includes: generating first configuration information, where the first configuration information includes one or both of the following indication information: whether cyclic shift is performed on a filter coefficient of a first communication apparatus, or whether cyclic shift is performed on data with the filter coefficient; and sending the first configuration information.

According to the foregoing implementation, in a scenario in which frequency domain resources of two terminals partially overlap or completely overlap, cyclic shift of corresponding filter coefficients may be configured for the two terminals, so that mutual interference between the two terminals can be reduced.

In a possible implementation, the first configuration information further includes the following indication information: a type of a filter of the first communication apparatus and precoding of the first communication apparatus.

For example, a value of the cyclic shift is preset, specified in a protocol, or configured by the access network device. For another example, the value of the cyclic shift is half of a quantity of subcarriers included in a frequency domain resource of the first communication apparatus.

In a possible implementation, the configuration information may further include indication information for a roll-off factor of the filter, and the roll-off factor of the filter may be specified in a protocol, preset, or configured by the access network device. The roll-off factor of the filter is a rational number greater than 0 and less than 1, or the roll-off factor of the filter is 0 or 1. For example, when the indication information indicates that cyclic shift is performed on one or both of the filter coefficient of the first communication apparatus or the data with the filter coefficient, the roll-off factor of the filter is 1.

In a possible implementation, the method further includes: generating second configuration information, where the second configuration information includes one or both of the following indication information: whether cyclic shift is performed on a filter coefficient of a third communication apparatus, or whether cyclic shift is performed on data with the filter coefficient; and sending the second configuration information. The frequency domain resource of the first communication apparatus partially or completely overlaps a frequency domain resource of the third communication apparatus.

Optionally, the third communication apparatus may receive the second configuration information, and perform, based on the second configuration information, cyclic shift on at least one of the filter coefficient of the third communication apparatus or the data with the filter coefficient.

According to the foregoing implementation, the first communication apparatus may be a terminal, or a chip or a circuit used in the terminal, and the third communication apparatus may be another terminal, or a chip, a circuit, or the like used in the another terminal. In this embodiment of this application, in a scenario in which partially overlapping or completely overlapping frequency domain resources are allocated to the two terminals, corresponding cyclic shift coefficients and the like are allocated to the two terminals, so that mutual interference between the two terminals can be reduced. For example, in an implementation, a filter coefficient of a terminal may be configured to perform cyclic shift, and a filter coefficient of another terminal may be configured not to perform cyclic shift.

According to a third aspect, an apparatus is provided. The apparatus includes a corresponding unit or module for performing the method according to the first aspect or the second aspect. The unit or the module may be implemented by a hardware circuit, or may be implemented by software, or may be implemented by a combination of a hardware circuit and software.

According to a fourth aspect, an apparatus is provided, including a processor and an interface circuit. The interface circuit is configured to receive a signal from an apparatus other than the apparatus and transmit the signal to the processor, or send a signal from the processor to an apparatus other than the apparatus, and the processor is configured to implement the method according to the first aspect or implement the method according to the second aspect through a logic circuit or by executing instructions.

According to a fifth aspect, an apparatus is provided, including a processor coupled to a memory. The processor is configured to execute a program stored in the memory, so as to perform the method according to the first aspect or the second aspect. The memory may be located inside the apparatus or outside the apparatus. In addition, there may be one or more processors.

According to a sixth aspect, an apparatus is provided, including a processor and a memory. The memory is configured to store computer instructions. When the apparatus runs, the processor executes the computer instructions stored in the memory, to enable the apparatus to perform the method according to the first aspect or the second aspect.

According to a seventh aspect, a chip system is provided, including a processor or a circuit, configured to perform the method according to the first aspect or the second aspect.

According to an eighth aspect, a computer-readable storage medium is provided. The computer-readable storage medium stores instructions, and when the instructions are run on a communication apparatus, the method according to the first aspect or the second aspect is performed.

According to a ninth aspect, a computer program product is provided. The computer program product includes a computer program or instructions, and when the computer program or the instructions are executed by an apparatus, the method according to the first aspect or the second aspect is performed.

According to a tenth aspect, a system is provided, including a first communication apparatus that performs the method according to the first aspect and a second communication apparatus that performs the method according to the second aspect.

For descriptions of technical effects that can be achieved in any one of the third aspect to the tenth aspect, refer to descriptions of corresponding technical effects in the first aspect or the second aspect. Repeated parts are not described.

### BRIEF DESCRIPTION OF DRAWINGS

FIG. 1 is a diagram of a communication system according to an embodiment of this application;

FIG. 2 is a diagram of a peak to average power ratio according to an embodiment of this application;

FIG. 3 is a diagram of a multicarrier signal according to an embodiment of this application;

FIG. 4 is a diagram of sending and receiving of a DFT-s-OFDM signal according to an embodiment of this application;

FIG. 5 is a diagram of sending in SC-QAM according to an embodiment of this application;

FIG. 6 is a diagram of sending in SC-OQAM according to an embodiment of this application;

FIG. 7 is a diagram of using a filter in DFT-s-OFDMS-OQAM according to an embodiment of this application;

FIG. 8 is a diagram of frequency domain shaping of DFT-s-OFDM-OQAM according to an embodiment of this application;

FIG. 9 is a diagram of a frequency domain of SC-OQAM according to an embodiment of this application;

FIG. 10 is another diagram of a frequency domain of SC-OQAM according to an embodiment of this application;

FIG. 11 is a diagram of overlapping frequency domain precoding of two terminals in SC-OQAM according to an embodiment of this application;

FIG. 12 is a flowchart of a communication method according to an embodiment of this application;

FIG. 13a to FIG. 13d show a solution of overlapping of a frequency domain of a plurality of terminals according to an embodiment of this application;

FIG. 14 is a diagram of reserving a subcarrier for a signal used for cyclic shift according to an embodiment of this application;

FIG. 15 is a diagram of sending a signal by a terminal according to an embodiment of this application;

FIG. 16 is a diagram of a structure of an apparatus according to an embodiment of this application; and

FIG. 17 is another diagram of a structure of an apparatus according to an embodiment of this application.

### DESCRIPTION OF EMBODIMENTS

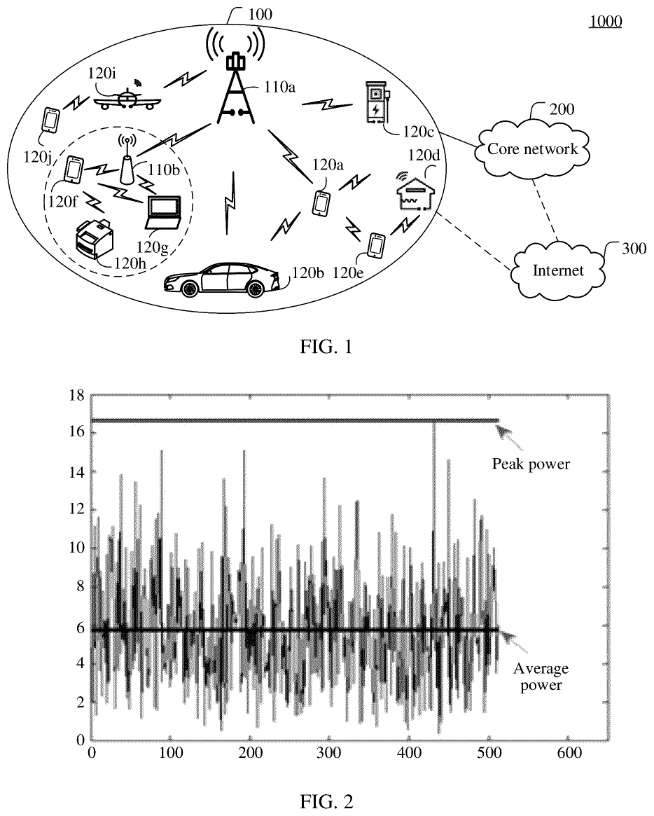

FIG. 1 is a diagram of an architecture of a communication system 1000 according to an embodiment of this application. As shown in FIG. 1, the communication system includes a radio access network 100 and a core network 200. Optionally, the communication system 1000 may further include an Internet 300. The radio access network 100 may include at least one access network device (for example, 110a and 110b in FIG. 1), and may further include at least one terminal (for example, 120a to 120j in FIG. 1). The terminal is connected to the access network device in a wireless manner, and the access network device is connected to the core network in a wireless or wired manner. A core network device and the access network device may be different physical devices that are independent of each other, or functions of the core network device and logical functions of the access network device may be integrated into a same physical device, or some functions of the core network device and some functions of the access network device may be integrated into one physical device. The terminals may be connected to each other in a wired or wireless manner, and the access network devices may be connected to each other in a wired or wireless manner. FIG. 1 is merely a diagram. The communication system may further include another network device, for example, may further include a wireless relay device and a wireless backhaul device, which are not shown in FIG. 1.

The access network device may be a base station (base station), an evolved NodeB (eNodeB), a transmission reception point (TRP), a next generation NodeB (gNB) in a 5th generation (5G) mobile communication system, a next generation NodeB in a 6th generation (6G) mobile communication system, a base station in a future mobile communication system, an access node in a wireless fidelity (Wi-Fi) system, or the like. The access network device may alternatively be a module or a unit that completes some functions of a base station, for example, may be a central unit (CU), or may be a distributed unit (DU). The CU herein completes functions of a radio resource control (RRC) protocol and a packet data convergence layer protocol PDCP) of a base station, and may further complete functions of a service data adaptation protocol (SDAP). The DU completes functions of a radio link control (RLC) layer and a medium access control (MAC) layer of a base station, and may further complete functions of some physical (PHY) layers or all physical layers. For specific descriptions of the foregoing protocol layers, refer to related technical specifications of a 3^{rd} generation partnership project (3GPP). The access network device may be a macro base station (for example, 110a in FIG. 1), a micro base station or an indoor base station (for example, 110b in FIG. 1), or a relay node, a donor node, or the like. A specific technology and a specific device form used by the access network device are not limited in embodiments of this application.

The terminal may also be referred to as a terminal device, a user equipment (UE), a mobile station, a mobile terminal, or the like. The terminal may be widely used in various scenarios, for example, device to device (D2D), vehicle to everything (V2X) communication, machine-type communication (MTC), internet of things (IOT), virtual reality, augmented reality, industrial control, automatic driving, telemedicine, a smart grid, smart furniture, a smart office, smart wearable, smart transportation, and a smart city. The terminal may be a mobile phone, a tablet computer, a computer with a wireless transceiver function, a wearable device, a vehicle, an uncrewed aerial vehicle, a helicopter, an airplane, a ship, a robot, a robot arm, a smart home device, or the like. A specific technology and a specific device form used by the terminal are not limited in embodiments of this application.

The access network device and the terminal may be at fixed positions, or may be movable. The access network device and the terminal may be deployed on land, including an indoor device, an outdoor device, a hand-held device, or a vehicle-mounted device; may be deployed on the water; or may be deployed on an airplane, a balloon, and an artificial satellite in the air. Application scenarios of the access network device and the terminal are not limited in embodiments of this application.

Roles of the access network device and the terminal may be relative. For example, a helicopter or an uncrewed aerial vehicle 120i in FIG. 1 may be configured as a mobile access network device. For a terminal 120j accessing the radio access network 100 through 120i, the terminal 120i is an access network device. However, for an access network device 110a, 120i is a terminal. In other words, 110a communicates with 120i by using a radio air interface protocol. Certainly, 110a and 120i may alternatively communicate with each other by using an interface protocol between access network devices. In this case, for 110a, 120i is also an access network device. Therefore, both the access network device and the terminal may be collectively referred to as a communication apparatus. 110a and 110b in FIG. 1 may be referred to as a communication apparatus having a function of the access network device, and 120a to 120j in FIG. 1 may be referred to as a communication apparatus having a function of the terminal.

Communication between an access network device and a terminal, between access network devices, or between terminals may be performed by using a licensed spectrum, an unlicensed spectrum, or both a licensed spectrum and an unlicensed spectrum; may be performed by using a spectrum below 6 gigahertz (GHz); may be performed by using a spectrum above 6 GHz; or may be performed by using both a spectrum below 6 GHz and a spectrum above 6 GHz. A spectrum resource used for wireless communication is not limited in embodiments of this application.

In embodiments of this application, functions of the access network device may alternatively be executed by a module (for example, a chip) in the access network device, or may alternatively be executed by a control subsystem including the functions of the access network device. The control subsystem including the functions of the access network device herein may be a control center in the foregoing application scenarios such as the smart grid, the industrial control, the smart transportation, and the smart city. Functions of the terminal may alternatively be executed by a module (for example, a chip or a modem) in the terminal, or may be executed by an apparatus including the functions of the terminal.

A peak to average power ratio (PAPR): A radio signal, observed in time domain, is a sine wave with a constantly changing amplitude, and the amplitude is not constant. An amplitude peak of the signal in a periodicity is different from an amplitude peak in another periodicity. Therefore, average power and peak power in all periodicities are different. As shown in FIG. 2, in a periodicity, the peak power is maximum transient power that occurs at a probability, and the probability is usually 1%. A ratio of the peak power to total average power of a system at this probability is the peak to average power ratio, referred to as PAPR for short.

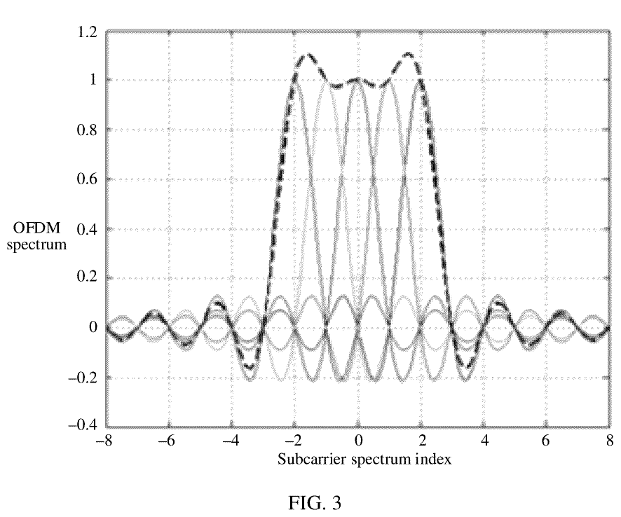

In a radio communication system, two main factors that affect the peak to average power ratio are: a peak to average power ratio of a baseband signal and a peak to average power ratio brought by multicarrier power superposition (with reference to FIG. 3). If the peak to average power ratio is excessively high, the following hazards exist:

Power amplification needs to be performed on a signal of the radio communication system before the signal is sent far away. Due to technical and cost limitations, a power amplifier usually performs linear amplification within only one range. Performing amplification within a range that exceeds the amplification range leads to signal distortion, and consequently, a receive end cannot correctly parse the signal due to signal distortion. To ensure that a peak of the signal falls within a linearity range of the power amplifier, a processing means is to reduce transmit power of the signal. Because the transmit power of the signal becomes lower, the peak power of the signal is usually lower, to ensure that the peak of the signal falls within the linearity range of the power amplification power, so as to avoid signal distortion.

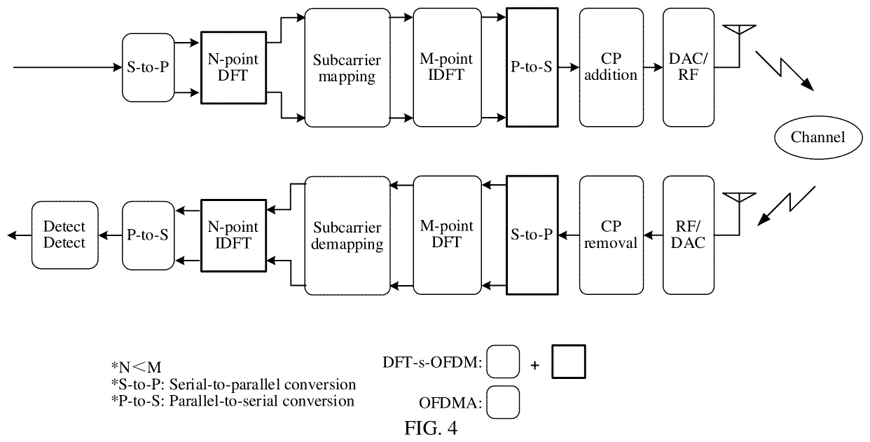

As described above, one of the main factors affecting the peak to average power ratio is the peak to average power ratio of the baseband signal. A technology for generating a baseband signal with a low peak to average power ratio includes discrete Fourier transform spread orthogonal frequency division multiplexing (DFT-s-OFDM). The technology is a variant of a cyclic prefix-orthogonal frequency division multiplexing (CP-OFDM) technology. A principle is as follows: As shown in FIG. 4, at a transmit end, after serial-to-parallel conversion is performed on a specific quantity of modulation symbols, N-point discrete Fourier transform (DFT) is performed to transform the modulation symbols to a frequency domain, and then a frequency domain signal is filtered or directly mapped to a subcarrier in frequency domain without filtering. This mapping process may be referred to as subcarrier mapping. M-point inverse discrete Fourier transform (IDFT) is performed on the frequency domain signal to convert the frequency domain signal into a time domain signal, serial-to-parallel conversion is performed on the time domain signal, a cyclic prefix (CP) is added, and the time domain signal is sent to a digital-to-analog converter (DAC) and radio frequency (RF) module for signal sending. A signal sent by the transmit end is transmitted to the receive end through an antenna. The receive end sends the received signal to the RF module and an analog-to-digital converter (ADC) to obtain a sampling signal. After a CP is removed from the sampling signal, serial-to-parallel conversion is performed. After the conversion, M-point DFT is performed to transform a time domain signal to the frequency domain, and N useful signals are extracted from the subcarriers in frequency domain. This process may be referred to as subcarrier demapping. Then, N-point IDFT transform is performed to obtain the time domain signal, and parallel-to-serial conversion is performed to obtain a serial time domain modulated signal. Because the DFT-s-OFDM is essentially a single carrier, physically in essence, a DFT-mapping-IDFT operation is actually equivalent to convolution performed on an input signal before the DFT and a sine (sin c) wave. Because the DFT-s-OFDM is essentially a single carrier, compared with the CP-OFDM and OFDM, the DFT-s-OFDM has a lower peak to average power ratio.

High frequency bands, mainly including frequency bands such as 28G, 39G, 60G, and 73G, become a research and development hotspot in the industry due to rich frequency band resources, to meet increasing communication requirements. In addition to a large bandwidth and a highly integrated antenna array for achieving a high throughput, significant features of the high frequency bands further include a severe intermediate frequency distortion problem, such as a severe path loss, phase noise (PHN), and a center frequency offset (CFO). In addition, a high-frequency Doppler frequency shift also becomes larger, and a phase error is introduced. As a result, performance of a high-frequency communication system deteriorates, and even the high-frequency communication system cannot work. A path loss exists when radio waves are propagated in the air. The path loss is directly proportional to a carrier frequency for signal transmission. The higher the frequency, the larger the path loss. Therefore, the path loss on a high frequency is severe. To improve receiving quality of a signal, increasing transmit power of the signal is a main solution for resisting a path loss. However, for broadband signals, especially a CP-OFDM signal and a DFT-s-OFDM signal, the signals each have a high peak to average power ratio, and excessively large transmit power may cause severe distortion of a power device. In a high-frequency communication scenario, to improve transmit power of a signal and avoid severe distortion of a power device caused by excessively high peak power, a waveform with a low peak to average power ratio may be selected. Single-carrier offset quadrature amplitude modulation (SC-OQAM) is a good option.

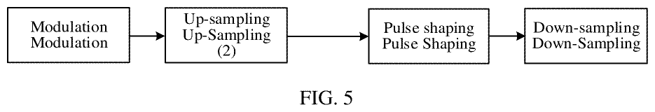

Implementation of conventional single-carrier quadrature amplitude modulation (SC-QAM) is shown in FIG. 5. In a first step, data information is modulated, that is, encoded 0 and 1 information is modulated into a modulated signal. This modulation scheme may be quadrature amplitude modulation (QAM), phase modulation, or another modulation scheme. This is not limited herein. In a second step, up-sampling is performed on the modulated signal, and a manner of up-sampling is not limited. An objective of the up-sampling is to repeat a modulated symbol. In a third step, a filter is used to filter a signal, which is also referred to as pulse shaping. An objective of filtering is to shape the signal, reduce a peak to average power ratio of the signal, limit a transmission bandwidth of the signal, remove interference, or the like. In a fourth step, down-sampling is performed on signals, where the down-sampling is to extract a signal. The extracted signal is sent to a radio frequency module and then sent to the receive end through an antenna. This is merely an example of implementation, and is not intended to limit this application. For example, there may be another implementation solution, which is not described herein one by one. However, steps such as modulation need to be performed, and steps of DFT transform and pulse shaping cannot be omitted.

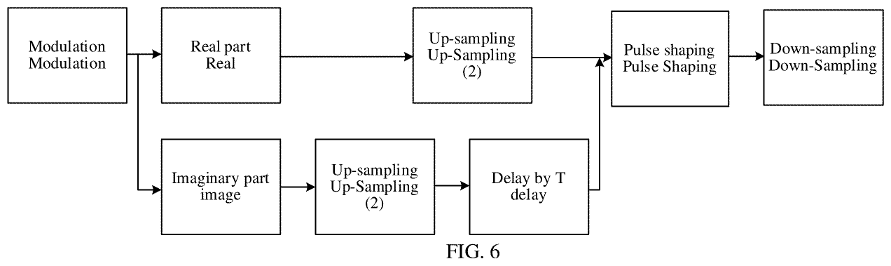

As shown in FIG. 6, compared with a block diagram of implementation of SC-QAM at a transmit end, a difference of SC-OQAM lies in that the modulated signal is a complex signal, an imaginary part and a real part of the complex signal are separated, and an imaginary-part signal is delayed by T. For the receive end, the imaginary part is removed when a real-part signal is received. When the imaginary-part signal is received, the real part is removed, so that the signal can be correctly demodulated. An advantage of orthogonality of the imaginary part and the real part lies in that, a peak of a real-part waveform is superimposed with a non-peak of the imaginary-part signal, and such a peak staggering manner can effectively reduce the peak to average power ratio. An OQAM implementation procedure is also merely an example of implementation, and is not intended to limit this application. There may be another implementation solution, which is not described herein one by one. However, modulation needs to be performed, and steps of real-imaginary separation, DFT transform, and pulse shaping cannot be omitted.

In this embodiment of this application, the DFT-s-OFDM technology and the SC-OQAM technology described above are combined, and may be referred to as a DFT-s-OFDM-OQAM technology. An essence of the technology is to separate a real part and an imaginary part of a signal, and then use a filter. Compared with a conventional complex implementation, this implementation has a lower peak to average power ratio. In this technology, data information is modulated to obtain a modulated signal. The modulated signal is split into a real part and an imaginary part. 2× up-sampling is performed on a real-part signal, and the real-part signal changes into [X, 0, X, 0, X, 0, . . . ]. 2× up-sampling is performed on an imaginary-part signal, and the imaginary-part signal changes into [jY, 0, jY, 0, jY, 0, . . . ]. The imaginary-part signal is delayed by T, and the imaginary-part signal changes into [0, jY, 0, jY, 0, jY, . . . ]. The imaginary-part signal and the real-part signal are combined to obtain a signal [X, jY, X, jY, X, jY, . . . ] whose real and imaginary parts are separated. A total length of the signal whose real and imaginary parts are separated is twice a length of the original modulated signal. Subsequently, 2N-point DFT needs to be performed on the signal whose real and imaginary parts are separated.

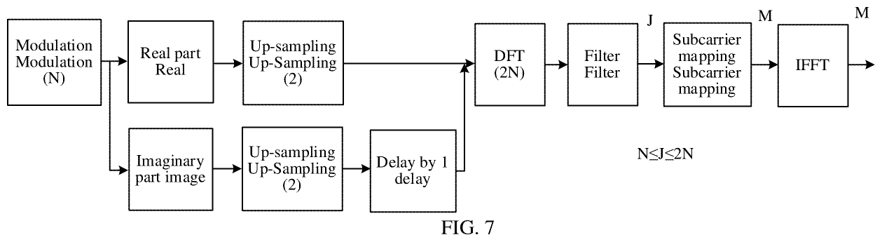

For example, as shown in FIG. 7, a to-be-sent signal is modulated by using N modulation symbols, to obtain N modulated signals. The modulated signal is a complex signal. According to the foregoing descriptions, real parts and imaginary parts of the N complex signals are separated, to obtain 2N complex signals. 2N-point DFT transform is performed on the 2N complex signals, where DFT transform is used to transform the 2N complex signals from time domain to a frequency domain, to obtain 2N frequency domain signals. A filter is used to perform filtering on the 2N frequency domain signals to obtain J frequency domain signals, where a value of J is greater than or equal to N and less than or equal to 2N. Subcarrier mapping is performed on the J frequency domain signals. A subcarrier mapping process may be considered as follows: J subcarriers are selected from M subcarriers, and the J frequency domain signals are mapped to the J subcarriers. Zero padding is performed on subcarriers other than the J subcarriers in the M subcarriers, and M-point inverse fast Fourier transform (IFFT) is performed. This may alternatively be described as that M frequency domain signals in the M subcarriers are transformed from the frequency domain to the time domain, to obtain M time domain signals. Then, CPs may be added to the M time domain signals, and the M time domain signals are sent to the receive end through the antenna.

As described above, the 2N frequency domain signals may be obtained through 2N DFT transform. As shown in FIG. 8, because a signal obtained through DFT is redundant, truncated frequency domain filtering may be performed on the redundant signal. Truncation means that a bandwidth of the filter is less than a bandwidth of the signal obtained through DFT. For example, the bandwidth of the signal obtained through the DFT is 100 resource blocks, and the filter may be designed to have a length of 60 resource blocks. A frequency domain filtering process is that a frequency domain filter is directly multiplied by the signal obtained through DFT. Alternatively, time domain filtering may be performed before the DFT. Details are not described herein. As shown in FIG. 8, the length of the filter may be 2N, and the length of a part of the filter is 0. Because the signal is redundant, the truncated filtering does not cause a performance loss.

By using a conjugate symmetry feature of an SC-OQAM waveform in the frequency domain signal, phase precoding may be performed on overlapping frequency domain signals of different terminals, to reduce channel interference between the different terminals and improve reception performance without changing the peak to average power ratio. For example, as shown in FIG. 9, for the 2N-point SC-OQAM signal described above, frequency domain signals that is not multiplied by a filter coefficient are conjugate symmetric, the conjugate symmetric signals are symmetric along center points of two segments of the frequency domain signals, and two segments of signals in the middle of a 2N-point frequency domain signal are asymmetric.

As shown in FIG. 10, the 2N-point frequency domain signal is multiplied by a filter coefficient, and data with a length of (1+a)N may be obtained, where data with a length of aN is redundant data. For two terminals, because there is a part of redundant data, data of the two terminals may be demodulated by using the redundant data and conjugate symmetry. Therefore, for overlapping at a single terminal, the filter is used to reduce the peak to average power ratio, and data demodulation performance can be improved.

For example, overlapping of the data of the two terminals is performed by using a conjugate symmetric center line of the two terminals. It is assumed that a signal of data of two conjugate symmetry points n1 and n2 at the receive end is:

$$[ \begin{matrix}y ( {n}_{1} ) \\ {y}^{*} ( {n}_{2} )\end{matrix} ] = [ \begin{matrix}{H}_{1} ( {n}_{1} ) & {e}^{j θ} {H}_{2} ( {n}_{1} ) \\ {H}_{1}^{*} ( {n}_{2} ) & {e}^{- j θ} {H}_{2}^{*} ( {n}_{2} )\end{matrix} ] [ \begin{matrix}x \\ {z}^{*}\end{matrix} ]$$

y(n₁) represents a received signal of the point n₁, and y*(n₂) represents performing a conjugate operation on a received signal of the point n₂. H₁ (n₁) represents a channel of a terminal 1 of the point n₁, e^{jθ} represents precoding, x represents a sending signal of the terminal 1, and z represents a sending signal of a terminal 2. An objective of the precoding is to minimize of equivalent channel correlation of the signals of the two terminals.

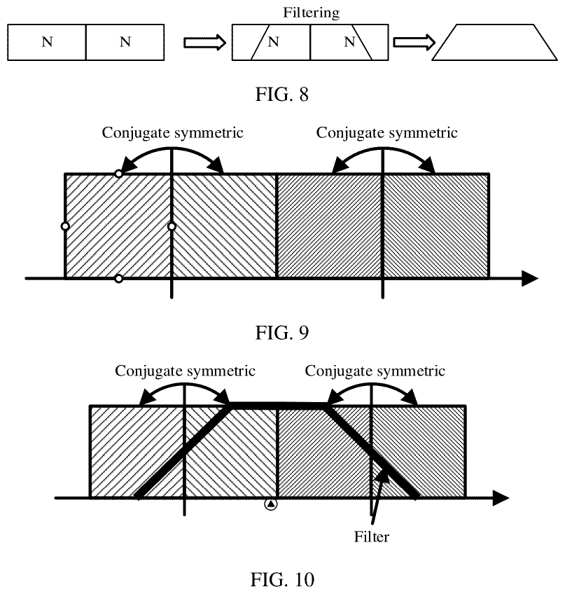

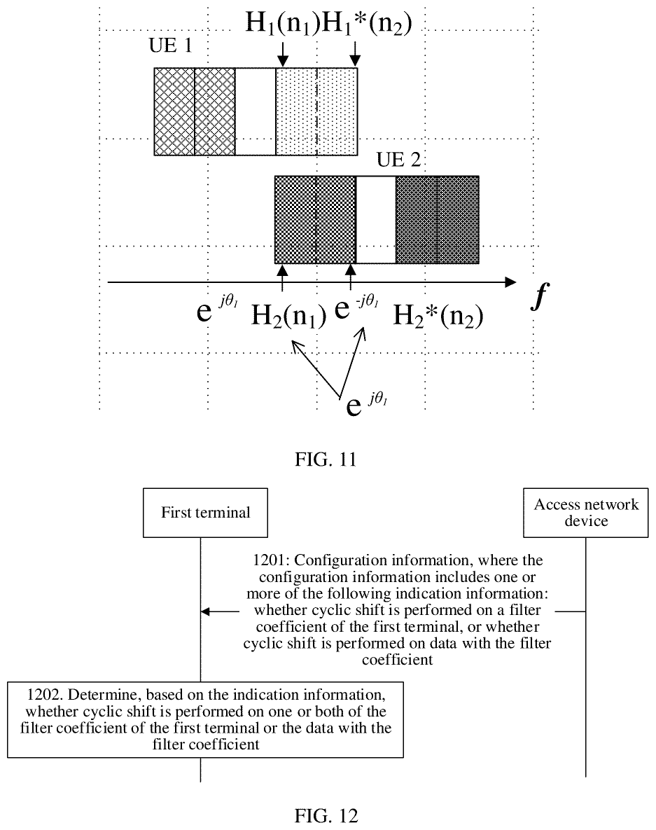

For example, as shown in FIG. 11, a frequency domain channel occupied by the terminal 1 partially overlaps a frequency domain channel occupied by the terminal 2. Specifically, the frequency domain channel of the terminal 1 is divided into five parts. If there is no filter, first two parts of the frequency domain channel are conjugate symmetric, a middle part of the frequency domain channel is not conjugate symmetric, and the last two parts of the frequency domain channel are conjugate symmetric. The frequency domain channel of the terminal 2 is also divided into five parts. If there is no filter, first two parts of the frequency domain channel are conjugate symmetric, a middle part of the frequency domain channel is not conjugate symmetric, and the last two parts of the frequency domain channel are conjugate symmetric. The last two parts of the frequency domain channel of the terminal 1 overlap the first two parts of the frequency domain channel of the terminal 2, causing mutual interference. The conjugate symmetry and the precoding of the frequency domain channels may be used to reduce or eliminate interference between the two terminals, so as to obtain a received signal.

In the example in FIG. 11, an example in which the precoding is performed on the overlapping part of the frequency domain channel of the terminal 2 is used for description. A correlation function “corr” may be used to calculate correlation between the overlapping frequency domain channels, so as to infer an angle \hat{θ} at which the correlation between the two channels is minimized. The precoding is performed on the overlapping frequency domain channel of the terminal 2 by using the angle \hat{θ} with minimum correlation obtained through inference:

$$\begin{matrix}corr = {( {H}_{1} )}^{H} {H}_{2} \\ = {e}^{j θ} {H}_{1}^{*} ( {n}_{1} ) {H}_{2} ( {n}_{1} ) + {e}^{- j θ} {H}_{1} ( {n}_{2} ) {H}_{2}^{*} ( {n}_{2} ) \\ = {e}^{j θ} {r}_{1} {e}^{j {β}_{1}} + {e}^{- j θ} {r}_{2} {e}^{j {β}_{2}}\end{matrix}$$

$$\hat{θ} = arg min ( \vert corr \vert )$$

Embodiments of this application provides a communication method. In the method, a first communication apparatus may receive configuration information. The configuration information may be sent by a second communication apparatus. The configuration information includes one or both of the following indication information: whether cyclic shift is performed on a filter coefficient of the first communication apparatus, or whether cyclic shift is performed on data with the filter coefficient. The first communication apparatus determines, based on the indication information, whether cyclic shift is performed on one or both of the filter coefficient of the first communication apparatus or the data with the filter coefficient.

The first communication apparatus may be a terminal, or a chip, a circuit, or the like used in the terminal. The chip may be a baseband chip or the like. This is not limited herein. The second communication apparatus may be an access network device, or a chip, a circuit, or the like used in the access network device. For example, the first communication apparatus is a first terminal, and the second communication apparatus is an access network device. As shown in FIG. 12, a procedure is provided, including the following steps.

Step 1201: The first terminal receives configuration information from the access network device, where the configuration information includes one or both of the following indication information: whether cyclic shift is performed on a filter coefficient of the first terminal, or whether cyclic shift is performed on data with the filter coefficient.

The configuration information may be downlink control information (DCI), a medium access control-control element (MAC-CE), system information, radio resource control signaling, or the like. This is not limited herein. The filter coefficient is a coefficient that is used to perform filtering by a filter. A filtering process may be considered as multiplying the filter coefficient by original data, and a result obtained may be considered as a result of filtering the original data. For example, a root-raised cosine (RRC) filter is used as an example, and the filter coefficient may be represented as [0.1, 0.8, 1.2, 1.3, 1.3, 1.2, 0.8, 0.1]. Optionally, data obtained after the original data is filtered may be referred to as data with the filter coefficient. Alternatively, in this embodiment of this application, cyclic shift may be performed on the data with the filter coefficient. Alternatively, cyclic shift may be performed on both the filter coefficient and the data with the filter coefficient. This is not limited herein.

Step 1202: The first terminal determines, based on the indication information, whether cyclic shift is performed on one or both of the filter coefficient of the first terminal or the data with the filter coefficient.

For example, the RRC filter is used as an example, and the RRC filter coefficient is represented as [0.1, 0.8, 1.2, 1.3, 1.3, 1.2, 0.8, 0.1]. If the indication information indicates that cyclic shift is performed on the RRC filter coefficient by half, a filter coefficient obtained through the cyclic shift may be represented as [1.3, 1.2, 0.8, 0.1, 0.1, 0.8, 1.2, 1.3]. Optionally, a value of the cyclic shift may be preset, specified in a protocol, configured by the access network device, or the like. This is not limited herein. For example, the access network device configures the value of the cyclic shift. The configuration information in step 1201 may further include indication information for the value of the cyclic shift and the like. Optionally, the value of the cyclic shift may be half of a quantity of subcarriers included in a frequency domain resource of the first terminal or half of a bandwidth. For example, if the frequency domain resource of the first terminal includes 10 subcarriers, the value of the cyclic shift may be 5.

Optionally, the configuration information in step 1201 may further include the following indication information: a type of a filter of the first terminal and precoding of the first terminal. The type of the filter may be an RRC filter, a rectangular window filter, or another filter. This is not limited herein. A roll-off factor of the filter of the first terminal may be specified in a protocol, preset, configured by the access network device, or the like. For example, the access network device configures the roll-off factor of the filter of the first terminal. The configuration information in step 1201 may further include indication information for the roll-off factor of the filter of the first terminal, and the like. In this embodiment of this application, the roll-off factor of the filter of the first terminal may be any number greater than 0 and less than 1, or the roll-off factor of the filter of the first terminal may be 0, 1, or the like. In a possible implementation, when the indication information in the configuration information in step 1201 indicates that cyclic shift is performed on one or both of the filter coefficient of the first terminal or the data with the filter coefficient, the roll-off factor of the filter is 1.

When cyclic shift is performed on the filter coefficient or the data with the filter coefficient, energy of a signal at an edge is large. The signal may be distorted when entering an amplifier or another device. In addition, the greater the energy of the signal at the edge, the stronger the interference. To reduce the interference, some subcarriers may be reserved at edges of a frequency band, where the subcarriers each may be a zero value signal, or a non-zero value signal whose power is less than a threshold, and the zero value signal may mean that no signal is transmitted. In this embodiment of this application, when the indication information in step 1201 indicates that cyclic shift is performed on one or both of the filter coefficient of the first terminal or the data with the filter coefficient, the method further includes: The first terminal may reserve M subcarriers outside a bandwidth of the first terminal, where a value of M is greater than 0, and perform transmission of a zero value signal on the reserved M subcarriers, or perform, on the reserved M subcarriers, transmission of a non-zero value signal whose power is less than a threshold.

Optionally, the value of M may be preset, specified in a protocol, configured by the access network device for the first terminal, or the like. This is not limited herein. The value of M is determined based on the bandwidth of the first terminal. For example, the value of M may satisfy the following condition: M=floor(a*BW), where floor represents rounding down, BW represents the bandwidth of the first terminal, and a is preset, specified in a protocol, or configured by the access network device for the first terminal. This is not limited herein. For example, a value of a may be 0.01. Alternatively, the value of M may be any fixed value ranging from 1 to K, and K may be any value ranging from 2 to 64. In an application scenario, the frequency domain resource of the first terminal may partially or completely overlap a frequency domain resource of a second terminal. Correspondingly, M subcarriers may also be reserved outside a bandwidth of the second terminal, to reduce in-band interference.

The following two specific implementations are provided based on the procedure shown in FIG. 12.

In a first implementation, the access network device indicates that cyclic shift needs to be performed on the filter coefficient of the first terminal and/or the data with the filter coefficient. The type of the filter of the first terminal may be an RRC filter, a rectangular window filter, or another filter. The access network device may indicate that the roll-off factor of the filter of the first terminal is any value ranging from 0 to 1; or the access network device may indicate the roll-off factor of the filter of the first terminal to be 0 or 1; or the roll-off factor of the filter of the first terminal is preset, or specified in a protocol. For example, the roll-off factor of the filter is 0.

In a second implementation, the access network device indicates that cyclic shift does not need to be performed on the filter coefficient of the first terminal and/or the data with the filter coefficient. The type of the filter of the first terminal may be an RRC or another filter. The roll-off factor of the filter of the first terminal may be preset, specified in a protocol, or the like. For example, the roll-off coefficient of the filter is 1. The value of the cyclic shift of the filter of the first terminal may be half of a quantity of subcarriers included in the bandwidth of the first terminal. For example, if the bandwidth of the first terminal includes 10 subcarriers, the value of the cyclic shift of the filter of the first terminal may be 5. M subcarriers are respectively reserved at two edges of the bandwidth of the first terminal. The M subcarriers are used for transmission of a zero value signal, a non-zero value signal whose power is less than a threshold, or the like. A value of M may be determined based on the bandwidth of the first terminal; or the value of M may be any value that ranges from 0 to 1 and that is preset or specified in a protocol; or the value of M may be configured by the access network device for the first terminal based on the configuration information, or the like. The configuration information may be DCI, a MAC-CE, a system message, radio resource control signaling, or the like. This is not limited herein.

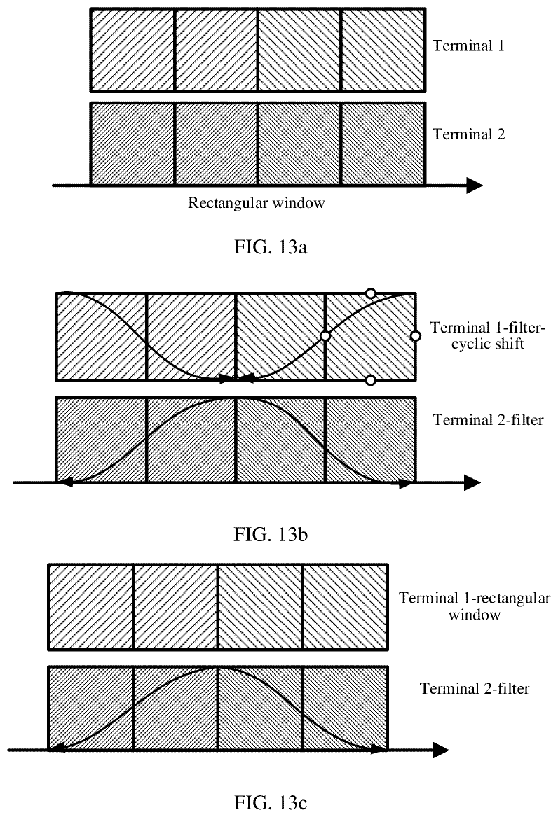

In this embodiment of this application, the frequency domain resource of the first terminal may partially or completely overlap the frequency domain resource of the second terminal. In an implementation, the access network device sends the configuration information in step 1201 to the first terminal, the configuration information in step 1201 may be referred to as first configuration information. Optionally, the implementation further includes: The access network device generates second configuration information, and the access network device sends the second configuration information to the second terminal, where the second configuration information includes at least one of the following indication information: whether cyclic shift is performed on a filter coefficient of the second terminal, or whether cyclic shift is performed on data with the filter coefficient. Further, the second terminal may determine, based on the second configuration information, whether cyclic shift is performed on the filter coefficient of the second terminal, or whether cyclic shift is performed on at least one of the data with the filter coefficient. For example, as shown in FIG. 13b, the access network device may configure one terminal (which may be referred to as a terminal 1) of the two terminals to perform cyclic shift, and configure the other terminal (which may be referred to as a terminal 2) not to perform cyclic shift.

Similarly, the second configuration information may further include at least one of the following indication information: a type of a filter of the second terminal and precoding of the second terminal. A value of the cyclic shift may be half of a quantity of subcarriers included in the frequency domain resource of the second terminal. Optionally, the second configuration information further includes indication information for a roll-off factor of the filter. The roll-off factor of the filter is a rational number greater than 0 and less than 1, or the roll-off factor of the filter is 0 or 1. When the configuration information includes the indication information indicating whether cyclic shift is performed on the filter coefficient of the first communication apparatus, or the indication information indicating whether cyclic shift is performed on the data with the filter coefficient, the roll-off factor of the filter is 1.

Optionally, when the configuration information includes the indication information indicating whether cyclic shift is performed on the filter coefficient of the first communication apparatus, or the indication information indicating whether cyclic shift is performed on the data with the filter coefficient, the method further includes: reserving M subcarriers outside a bandwidth of the first communication apparatus, where M is an integer greater than 0, and performing transmission of a zero value signal on the reserved M subcarriers, or performing, on the reserved M subcarriers, transmission of a non-zero value signal whose power is less than a threshold, where a value of M is determined based on the bandwidth of the first communication apparatus. For a specific process, refer to the foregoing configuration process of the first terminal. Details are not described again. It should be noted that, in addition to the second terminal, the foregoing method may be performed by a chip, a circuit, or the like in the second terminal. The second terminal, and the chip, the circuit, or the like in the second terminal may be collectively referred to as a third communication apparatus.

For example, the access network device allocates a same frequency domain resource to the first terminal and the second terminal. Half of the frequency domain resource is redundant, and the redundant frequency domain resource is conjugately symmetric to the non-redundant frequency domain resource. For example, the frequency domain resources of the two terminals may be both 2N-point frequency domain resources.

As shown in FIG. 13a, neither the terminal 1 nor the terminal 2 may use a filter, and both the terminal 1 and the terminal 2 send data by using rectangular windows. From a perspective of a single terminal, compared with a conventional DFT-s-OFDM solution, a block error rate (block error rate, BLER) has no significant loss, and a peak to average power ratio slightly increases.

As shown in FIG. 13b, both the terminal 1 and the terminal 2 use filters to reduce peak to average power ratios. In addition, to reduce the BLERs of the terminals, cyclic shift is performed on a filter coefficient of one of the terminals or data with the filter coefficient. The following describes a principle by using an example. It is assumed that signals of data of two conjugate symmetry points n₁ and n₂ on a receive side are:

$${y}_{1} = {h}_{1} ( {n}_{1} ) {x}_{1} + {h}_{2} ( {n}_{1} ) exp ( j θ ) {z}_{1}^{*}$$

$${y}_{2} = {h}_{1} ( {n}_{2} ) {x}_{1}^{*} + {h}_{2} ( {n}_{2} ) exp ( j θ ) {z}_{1}$$

y₁ represents a received signal of the point n₁, and y₂ represents a received signal of the point n₂. h₁(n₁) represents a channel of the terminal 1 of the point n₁, e^{jθ} represents precoding, x₁ represents a sending signal of the terminal 1, and z₁ represents a sending signal of the terminal 2. For data demodulation of the terminal 1, the following is obtained:

$$\begin{matrix}{x}_{1} = [ \begin{matrix}{h}_{1}^{*} ( {n}_{1} ) & {h}_{1} ( {n}_{2} )\end{matrix} ] [ \begin{matrix}{y}_{1} \\ {y}_{2}^{*}\end{matrix} ] \\ = {h}_{1}^{*} ( {n}_{1} ) {h}_{1} ( {n}_{1} ) {x}_{1} + {h}_{1}^{*} ( {n}_{1} ) {h}_{2} ( {n}_{1} ) exp ( j θ ) {z}_{1}^{*} \\ + {h}_{1}^{*} ( {n}_{2} ) {h}_{1} ( {n}_{2} ) {x}_{1} + {h}_{1} ( {n}_{2} ) {h}_{2}^{*} ( {n}_{2} ) exp ( - j θ ) {z}_{1}^{*}\end{matrix}$$

A distracter is extracted to obtain the following:

$$I = {h}_{1}^{*} ( {n}_{1} ) {h}_{2} ( {n}_{1} ) {z}_{1}^{*} exp ( j θ ) + {h}_{1} ( {n}_{2} ) {h}_{2}^{*} ( {n}_{2} ) {z}_{1}^{*} exp ( - j θ )$$

exp(jθ) is introduced to make phases of the two summation items hⱼ*(n₁)h₂(n₁) and h₁(n₂)h₂*(n₂) as opposite as possible. To make a value of I as small as possible, amplitudes of the two items need to be close. For the terminal 2 in a solution in FIG. 13b, a value of the terminal 2 is small at edges of a frequency band. If the terminal 1 uses a same filter solution as the terminal 2, power of signals of the two terminals at the edges is very small, that is, an amplitude of h₁*(n₁)h₂(n₁) is far less than an amplitude of h₁(n₂)h₂*(n₂), where n₁=1. As a result, the value of I is very large, in other words, interference is very strong. To reduce the interference, cyclic shift needs to be performed on data and/or a filter of one of the terminals, so that the terminal 1 and the terminal 2 have both a large value and a small value at a same time point, and the amplitude of h₁*(n₁)h₂(n₁) is close to the amplitude of h₁(n₂)h₂*(n₂). In this way, the value of I is very small. From a perspective of a single terminal, compared with a conventional DFT-s-OFDM solution, this solution has no significant loss in terms of the BLER. One of the terminals has a slight loss, but the other terminal has significant improvement.

As shown in FIG. 13c, the terminal 1 does not use a filter, but use a rectangular window. The terminal 2 uses a filter. For the terminal 1 and the terminal 2, the BLER has a loss, but performance of the peak to average power ratios is improved, especially for the terminal 2, the performance of the peak to average power ratio of the terminal 2 is improved significantly.

As shown in FIG. 13d, a solution is different from the solutions in FIG. 13a, FIG. 13b, and FIG. 13c described above. The access network device allocates frequency domain resources of a same size to the terminal 1 and the terminal 2. However, the frequency domain resources of the terminal 1 and the terminal 2 do not completely overlap, and the frequency domain resources partially overlap. Half of the frequency domain resources are redundant, and the redundant frequency domain resources are conjugately symmetric to the non-redundant frequency domain resources. In other words, the frequency domain resources of the two terminals are both 2N-point frequency domain resources. In this design, both the terminal 1 and the terminal 2 use filters, to reduce the peak to average power ratios. For the terminal 1 and the terminal 2, the BLERs have a loss, but the performance of the peak to average power ratios is greatly improved.

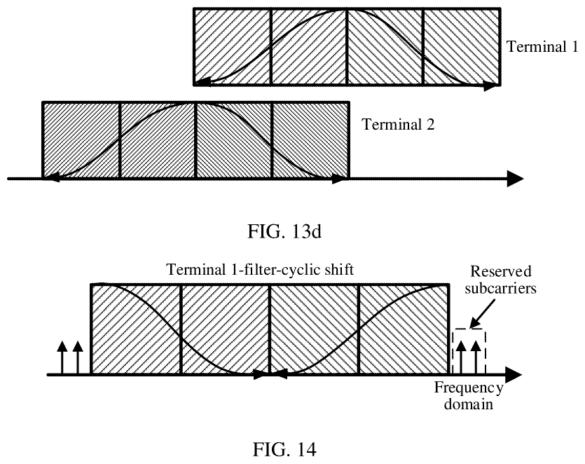

Further, as shown in FIG. 14, in a solution in FIG. 13d, a problem further needs to be resolved, that is, when cyclic shift is performed on the filter coefficient or the data with the filter coefficient, because energy of a signal at an edge is large, distortion may occur when the signal enters an amplifier or another device. In addition, the greater the energy of the signal at the edge, the stronger the interference. To reduce the interference, M subcarriers may be reserved at two edges of the frequency band. The M subcarriers may be used for transmission of a zero value signal, a non-zero value signal whose power is less than a threshold, or the like. This is not limited herein.

This embodiment of this application further provides a solution. The solution may be a specific implementation of the procedure in FIG. 12, including: The access network device sends configuration information to a terminal, where the configuration information is used to configure a type of a filter, precoding, whether cyclic shift is performed, and the like that are used by the terminal during data sending. The cyclic shift may be cyclic shift of the filter, cyclic shift of the filter coefficient, cyclic shift of the data with the filter coefficient, or the like.

In a design, when the access network device configures that cyclic shift is not needed for the terminal, the type of the filter configured for the terminal may be an RRC filter, a rectangular window filter, or another filter. This is not limited herein. Further, the configuration information may be further used to configure a roll-off factor of the filter. The roll-off factor may be any value ranging from 0 to 1, or the roll-off factor may be 0 or 1, or the roll-off factor may be a preset value 0, or the like. In this embodiment of this application, parameters of the foregoing filters may be jointly configured, or parameters of the filters may be separately configured. This is not limited herein. For example, a cyclic shift offset value and the roll-off factor may be jointly configured, or a cyclic shift offset value and the type of the filter may be jointly configured, or a cyclic shift offset value and the precoding may be jointly configured. This is not limited herein. The cyclic shift offset value is a specific cyclic shift value when cyclic shift is performed on the filter coefficient or the data with the filter coefficient.

When cyclic shift is performed on the filter coefficient, the roll-off factor of the filter may be set to 1, and a value of the cyclic shift (that is, the cyclic shift offset value) may be half of a quantity of subcarriers included in a bandwidth of the terminal. Cyclic shift may be performed on the filter coefficient, the data with the filter coefficient, or the like. This is not limited herein. A value of M for the reserved subcarriers may be determined based on the bandwidth of the terminal, preset, specified in a protocol, configured by the access network device for the terminal, or the like. This is not limited herein.

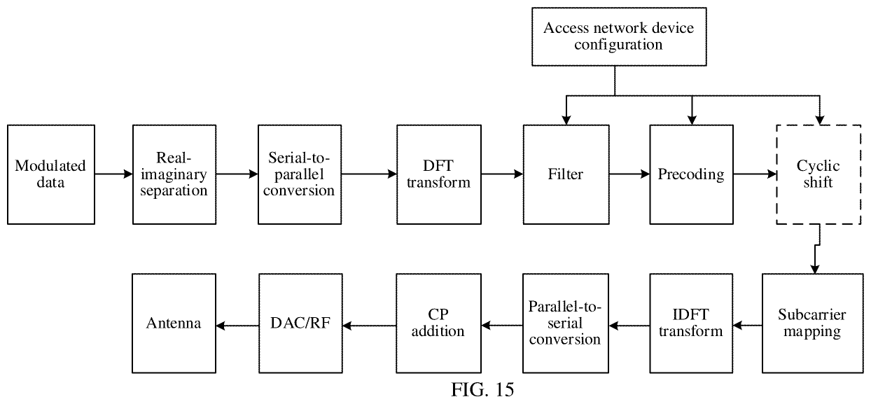

In a possible implementation, as shown in FIG. 15, the access network device may configure, for the terminal, information such as the type of the filter, the precoding, and whether cyclic shift is performed. A processing procedure on a terminal side includes: The terminal modulates data to obtain modulated data. Real-imaginary separation is performed on the modulated data to obtain a real-part signal and an imaginary-part signal. Serial-to-parallel conversion and DFT transform are performed on the real-part signal and the imaginary-part signal. Data obtained through the DFT transform is filtered based on information such as the type of the filter, the precoding, and the cyclic shift that are configured by the access network device. Filtered data is processed through subcarrier mapping, IDFT transform, the parallel-to-serial conversion, CP addition, DAC/RF, and the like, and then sent to the receive end through the antenna.

It may be understood that, to implement functions in the foregoing embodiments, the access network device and the terminal include corresponding hardware structures and/or software modules for executing various functions. A person skilled in the art should be easily aware that, in this application, the units and method steps in the examples described with reference to embodiments disclosed in this application can be implemented by hardware or a combination of hardware and computer software. Whether a function is executed by using hardware or hardware driven by computer software depends on particular application scenarios and design constraint conditions of technical solutions.

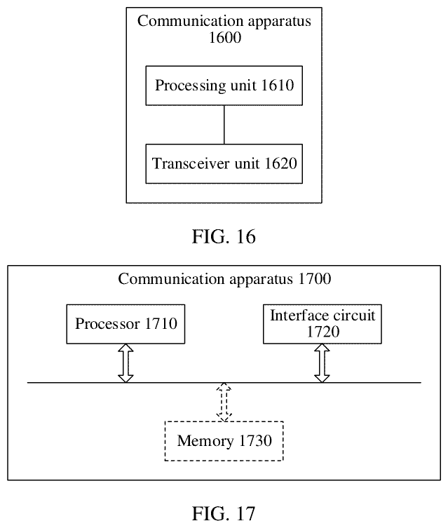

FIG. 16 and FIG. 17 each are a diagram of a structure of a possible communication apparatus according to an embodiment of this application. These communication apparatuses may be configured to implement the functions of the terminal or the access network device in the foregoing method embodiments, and therefore may implement beneficial effects of the foregoing method embodiments. In this embodiment of this application, the communication apparatus may be one of the terminals 120a to 120j shown in FIG. 1, or may be the base station 110a or 110b shown in FIG. 1, or may be a unit (for example, a chip) used in a terminal or an access network device.

As shown in FIG. 16, a communication apparatus 1600 includes a processing unit 1610 and a transceiver unit 1620. The communication apparatus 1600 is configured to implement the functions of the terminal or the access network device in the foregoing method embodiments.

When the communication apparatus 1600 is configured to implement the functions of the terminal in the foregoing method embodiment, the transceiver unit 1620 is configured to receive configuration information, where the configuration information includes one or both of the following indication information: whether cyclic shift is performed on a filter coefficient of a first communication apparatus, or whether cyclic shift is performed on data with the filter coefficient; and the processing unit 1610 is configured to determine, based on the indication information, whether cyclic shift is performed on one or both of the filter coefficient of the first communication apparatus or the data with the filter coefficient.

In a possible implementation, the configuration information further includes the following indication information: a type of a filter of the first communication apparatus and precoding of the first communication apparatus.

In a possible implementation, a value of the cyclic shift is preset, specified in a protocol, or configured by the access network device.

In a possible implementation, the value of the cyclic shift is half of a quantity of subcarriers included in a frequency domain resource of the first communication apparatus.

In a possible implementation, the configuration information further includes indication information for a roll-off factor of the filter.

In a possible implementation, the roll-off factor of the filter is a rational number greater than 0 and less than 1, or the roll-off factor of the filter is 0 or 1.

In a possible implementation, the roll-off factor of the filter is a rational number greater than 0 and less than 1, or the roll-off factor of the filter is 0 or 1.

In a possible implementation, when the configuration information includes the indication information indicating whether cyclic shift is performed on the filter coefficient of the first communication apparatus, or the indication information indicating whether cyclic shift is performed on the data with the filter coefficient, the roll-off factor of the filter is 1.

In a possible implementation, the frequency domain resource of the first communication apparatus partially or completely overlaps a frequency domain resource of a third communication apparatus.

In a possible implementation, when the configuration information includes the indication information indicating whether cyclic shift is performed on the filter coefficient of the first communication apparatus, or the indication information indicating whether cyclic shift is performed on the data with the filter coefficient, the method further includes:

M subcarriers are reserved outside a bandwidth of the first communication apparatus, where M is an integer greater than 0, and transmission of a zero value signal is performed on the reserved M subcarriers, or transmission of a non-zero value signal whose power is less than a threshold is performed on the reserved M subcarriers, where a value of M is determined based on the bandwidth of the first communication apparatus.

When the communication apparatus 1600 is configured to implement functions of the access network device in the foregoing method embodiment, the processing unit 1610 is configured to generate first configuration information, where the first configuration information includes one or both of the following indication information: whether cyclic shift is performed on a filter coefficient of the first communication apparatus, or whether cyclic shift is performed on data with the filter coefficient; and the transceiver unit 1620 is configured to send the first configuration information.

In a possible implementation, the first configuration information further includes the following indication information: a type of a filter of the first communication apparatus and precoding of the first communication apparatus.

In a possible implementation, a value of the cyclic shift is preset, specified in a protocol, or configured by the access network device.

In a possible implementation, the value of the cyclic shift is half of a quantity of subcarriers included in a frequency domain resource of the first communication apparatus.

In a possible implementation, the first configuration information further includes indication information for a roll-off factor of the filter. In a possible implementation, the roll-off factor of the filter is a rational number greater than 0 and less than 1, or the roll-off factor of the filter is 0 or 1.

In a possible implementation, when the first configuration information includes the indication information indicating whether cyclic shift is performed on the filter coefficient of the first communication apparatus, or the indication information indicating whether cyclic shift is performed on the data with the filter coefficient, the roll-off factor of the filter is 1.

In a possible implementation, the communication apparatus further includes: the processing unit 1610, further configured to generate second configuration information, where the second configuration information includes one or both of the following indication information: whether cyclic shift is performed on a filter coefficient of a third communication apparatus, or whether cyclic shift is performed on data with the filter coefficient, and the frequency domain resource of the first communication apparatus partially or completely overlaps a frequency domain resource of the third communication apparatus; and the transceiver unit 1620, further configured to send the second configuration information.

For more detailed descriptions of the processing unit 1610 and the transceiver unit 1620, related descriptions in the foregoing method embodiments may be directly referred to. Details are not described herein.

As shown in FIG. 17, a communication apparatus 1700 includes a processor 1710 and an interface circuit 1720. The processor 1710 and the interface circuit 1720 are coupled to each other. It may be understood that the interface circuit 1720 may be a transceiver or an input/output interface. Optionally, the communication apparatus 1700 may further include a memory 1730, configured to store instructions to be executed by the processor 1710, or store input data required by the processor 1710 to run the instructions, or store data generated after the processor 1710 runs the instructions.

When the communication apparatus 1700 is configured to implement the functions of the methods shown in the foregoing method embodiments, the processor 1710 is configured to implement functions of the foregoing processing unit 1610, and the interface circuit 1720 is configured to implement functions of the foregoing transceiver unit 1620.

When the communication apparatus is a chip used in a terminal, the terminal chip implements the functions of the terminal in the foregoing method embodiments. The terminal chip receives information from another module (for example, a radio frequency module or an antenna) in the terminal, where the information is sent by an access network device to the terminal. Alternatively, the terminal chip sends information to another module (for example, the radio frequency module or the antenna) in the terminal, where the information is sent by the terminal to the access network device.

When the foregoing communication apparatus is a module used in the access network device, the access network device module implements functions of the access network device in the foregoing method embodiments. The access network device module receives information from another module (for example, a radio frequency module or an antenna) in the access network device, where the information is sent by the terminal to the access network device. Alternatively, the access network device module sends information to another module (for example, the radio frequency module or the antenna) in the access network device, where the information is sent by the access network device to the terminal. The access network device module herein may be a baseband chip of the access network device, or may be a DU or another module. The DU herein may be a DU in an open radio access network (O-RAN) architecture.

It may be understood that, the processor in embodiments of this application may be a central processing unit (CPU), or may be another general-purpose processor, a digital signal processor (DSP), an application specific integrated circuit (ASIC), a field programmable gate array (FPGA) or another programmable logic device, a transistor logic device, a hardware component, or any combination thereof. The general-purpose processor may be a microprocessor or any regular processor.

The method steps in embodiments of this application may be implemented in a hardware manner, or may be implemented in a manner of executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor can read information from the storage medium and write information into the storage medium. Certainly, the storage medium may also be a component of the processor. The processor and the storage medium may be located in an ASIC. In addition, the ASIC may be located in an access network device or a terminal. Certainly, the processor and the storage medium may also exist in the access network device or the terminal as discrete components.

The foregoing embodiments may be implemented by using software, hardware, firmware, or any combination thereof in whole or in part. When software is used for implementation, the foregoing embodiments may be implemented in whole or in part in a form of a computer program product. The computer program product includes one or more computer programs or instructions. When the computer program or the instructions are loaded and executed on a computer, the procedures or functions in embodiments of this application are executed in whole or in part. The computer may be a general-purpose computer, a special-purpose computer, a computer network, a network device, a user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

In this application, “at least one” means one or more, and “a plurality of” means two or more than two. “And/or” describes an association relationship between associated objects and represents that three relationships may exist. For example, A and/or B may represent the following cases: Only A exists, both A and B exist, and only B exists, where A and B may be singular or plural. In the text descriptions of this application, the character “/” usually represents an “or” relationship between the associated objects. In a formula in this application, the character “/” represents a “division” relationship between the associated objects. “Including at least one of A, B, and C” may represent: including A; including B; including C; including A and B; including A and C; including B and C; and including A, B, and C.

It may be understood that various numbers in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

1. A communication method, comprising:
receiving configuration information, wherein the configuration information comprises one or both of the following indication information: whether cyclic shift is performed on a filter coefficient of a first communication apparatus, or whether cyclic shift is performed on data with the filter coefficient; and
determining, based on the indication information, whether cyclic shift is performed on one or both of the filter coefficient of the first communication apparatus or the data with the filter coefficient.

2. The method according to claim 1, wherein the configuration information further comprises the following indication information: a type of a filter of the first communication apparatus and precoding of the first communication apparatus.

3. The method according to claim 1, wherein a value of the cyclic shift is preset, specified in a protocol, or configured by an access network device.

4. The method according to claim 3, wherein the value of the cyclic shift is half of a quantity of subcarriers comprised in a frequency domain resource of the first communication apparatus.

5. The method according to claim 1, wherein the configuration information further comprises indication information for a roll-off factor of the filter.

6. The method according to claim 5, wherein the roll-off factor of the filter is a rational number greater than 0 and less than 1, or the roll-off factor of the filter is 0 or 1.

7. The method according to claim 6, wherein when the configuration information comprises the indication information indicating whether cyclic shift is performed on the filter coefficient of the first communication apparatus, or the indication information indicating whether cyclic shift is performed on the data with the filter coefficient, the roll-off factor of the filter is 1.

8. The method according to claim 1, wherein when the configuration information comprises the indication information indicating whether cyclic shift is performed on the filter coefficient of the first communication apparatus, or the indication information indicating whether cyclic shift is performed on the data with the filter coefficient, the method further comprises:
reserving M subcarriers outside a bandwidth of the first communication apparatus, wherein M is an integer greater than 0, and performing transmission of a zero value signal on the reserved M subcarriers, or performing, on the reserved M subcarriers, transmission of a non-zero value signal whose power is less than a threshold, wherein a value of M is determined based on the bandwidth of the first communication apparatus.

9. A communication method, comprising:
generating first configuration information, wherein the first configuration information comprises one or both of the following indication information: whether cyclic shift is performed on a filter coefficient of a first communication apparatus, or whether cyclic shift is performed on data with the filter coefficient; and
sending the first configuration information.

10. The method according to claim 9, wherein the first configuration information further comprises the following indication information: a type of a filter of the first communication apparatus and precoding of the first communication apparatus.

11. The method according to claim 9, wherein a value of the cyclic shift is preset, specified in a protocol, or configured by an access network device.

12. The method according to claim 11, wherein the value of the cyclic shift is half of a quantity of subcarriers comprised in a frequency domain resource of the first communication apparatus.

13. The method according to claim 9, wherein the first configuration information further comprises indication information for a roll-off factor of the filter.

14. The method according to claim 13, wherein the roll-off factor of the filter is a rational number greater than 0 and less than 1, or the roll-off factor of the filter is 0 or 1.

15. The method according to claim 14, wherein when the first configuration information comprises the indication information indicating whether cyclic shift is performed on the filter coefficient of the first communication apparatus, or the indication information indicating whether cyclic shift is performed on the data with the filter coefficient, the roll-off factor of the filter is 1.

16. The method according to claim 9, wherein the method further comprises:
generating second configuration information, wherein the second configuration information comprises one or both of the following indication information: whether cyclic shift is performed on a filter coefficient of a third communication apparatus, or whether cyclic shift is performed on data with the filter coefficient, and the frequency domain resource of the first communication apparatus partially overlaps or completely overlaps a frequency domain resource of the third communication apparatus; and
sending the second configuration information.

17. A non-transitory computer-readable storage medium, wherein storage medium coupled to one or more processors and storing programming instructions for execution by the one or more processors, the programming instructions instruct the processor to:
receiving configuration information, wherein the configuration information comprises one or both of the following indication information: whether cyclic shift is performed on a filter coefficient of a first communication apparatus, or whether cyclic shift is performed on data with the filter coefficient; and
determining, based on the indication information, whether cyclic shift is performed on one or both of the filter coefficient of the first communication apparatus or the data with the filter coefficient.
